(19) United States
(12) Patent Application Publication
(10) Pub. No.: US 2011/0320611 A1
(43) Pub. Date: Dec. 29, 2011

(54) WIRELESS COMMUNICATION DEVICE AND WIRELESS COMMUNICATION SYSTEM

(75) Inventors: Hajime INADA, Chiryu (JP); Isamu KITAGAWA, Kasugai (JP)

(73) Assignee: BROTHER KOGYO KABUSHIKI KAISHA, Aichi (JP)

(21) Appl. No.: 13/168,397

(22) Filed: Jun. 24, 2011

(30) Foreign Application Priority Data
Jun. 24, 2010 (JP) 2010-143793

(51) Int. Cl. G06F 15/16

(52) U.S. Cl. 709/227

(57) ABSTRACT

A communication device includes an identification information storage stores identification information based on which a predetermined terminal device is identified, an initial setting storage storing, as an initial setting, a communication setting with which a direct communication is enabled with respect to the predetermined terminal device identified by the identification information stored in the identification information storage, an acquiring unit acquires a connection setting to connect an access point, a transmission unit transmits the connection setting acquired by the acquiring unit and an instruction to connect with the access point in accordance with the connection setting to the predetermined terminal deice in accordance with the initial setting stored in the initial setting storage, and a setting unit makes the communication device connectable to the access point with the connection setting acquired by the acquiring unit after the connection setting and the instruction are transmitted by the transmission unit.

### CROSS-REFERENCE TO RELATED APPLICATION

This application claims priority under 35 U.S.C. §119 from Japanese Patent Application No. 2010-143793 filed on Jun. 24, 2010. The entire subject matter of the application is incorporated herein by reference.

### BACKGROUND

1. Technical Field

Aspects of the present invention relate to a wireless communication device and a wireless communication system.

2. Related Art

Conventionally, there is known a technique according to which, under an environment where a PC (personal computer) is connected with a wireless LAN (local area network) access point router, a wireless connection between an Internet radio and the PC is established via the wireless LAN access point router.

The above-described conventional art does not suggest the connection of the Internet radio and the PC so that a communication therebetween via the wireless LAN access point router is enabled. It is conventionally known that, in order to connect two communication devices in parallel so that a communication therebetween via the wireless LAN access point router is enabled, a user is required to operate the two communication devices separately and individually to connect with the access point.

### SUMMARY

As described above, according to the conventional art, in order to connects two communication device with an access point so that the two communication devices can communicate with each other via the access point, troublesome operations should be done by the user.

In consideration of the above problem, aspects of the invention provide a communication device, provided with an identification information storage configured to store identification information based on which a predetermined terminal device is identified, an initial setting storage storing, as an initial setting, a communication setting with which a direct communication is enabled with the predetermined terminal device identified by the identification information stored in the identification information storage, an acquiring unit configured to acquire a connection setting to connect an access point, a transmission unit configured to transmit the connection setting acquired by the acquiring unit and an instruction to connect with the access point in accordance with the connection setting to the predetermined terminal deice in accordance with the initial setting stored in the initial setting storage, and a setting unit configured to make the communication device connectable to the access point with the connection setting acquired by the acquiring unit after the connection setting and the instruction are transmitted by the transmission unit.

According to aspects of the invention, there is also provided a communication device, which is provided with an identification information storage configured to store identification information with which a predetermined terminal device can be identified, an initial setting storage storing, as an initial setting, a communication setting with which a direct communication is enabled with the predetermined terminal device identified by the identification information stored in the identification information storage, a receiving unit configured to receive a connection setting to connect with an access point and an instruction to connect the communication device to connect with the access point in accordance with the connection setting from the predetermined terminal device in accordance with the initial setting stored in the initial setting storage, and a setting unit configured to set the communication device connectable to the access point in accordance with the connection setting received by the receiving unit after receiving the connection setting and the instruction with use of the receiving unit.

According to further aspects of the invention, there is also provided a wireless communication system, which includes a first communication device comprising a first identification information storage storing first identification information based on which a second communication device is identified, and a first initial setting storage storing, as initial setting, a communication setting enabling a direct wireless communication with the second communication device identified by the first identification information stored in the first identification information storage, a second communication device comprising a second identification information storage storing second identification information based on which the first communication device is identified, and a second initial setting storage storing, as initial setting, a communication setting enabling a direct wireless communication with the first communication device identified by the second identification information stored in the second identification information storage.

The first communication device further includes an acquiring unit configured to acquire a connection setting to connect with an access point, a transmission unit configured to transmit the connection setting acquired by the acquiring unit and an instruction to connect with the access point in accordance with the connection setting to the second communication device in accordance with the initial setting stored in the first initial setting storage, and a first setting unit configured to set the first communication device connectable to the access point in accordance with the connection setting acquired by the acquiring unit after transmitting the connection setting and the instruction with the transmission unit. Further, the second communication device includes a receiving unit configured to receive, in accordance with the initial setting stored in the second initial setting storage, the connection setting and the instruction transmitted from the first communication device using the transmission unit, and a second setting unit configured to set the second communication device connectable to the access point in accordance with the connection setting received by the receiving unit after the connection setting and the instruction are received by the receiving unit.

### BRIEF DESCRIPTION OF THE ACCOMPANYING DRAWINGS

FIG. 1 is a perspective view showing appearances of an MFP (multi function peripheral), LCU(line control unit) and AP (access point) according to aspects of the invention.

FIG. 2 is a block diagram showing electric configuration of the MFP, LCU and AP shown in FIG. 1.

FIG. 3 is a flowchart illustrating a paring process of the MFP according to a first embodiment of the invention.

FIG. 4 is a flowchart illustrating a setting confirmation process of the MFP according to the first embodiment of the invention.

FIG. 5 is a flowchart illustrating an MFP setting change process of the MFP according to aspects of the invention.

FIG. 6 is a flowchart illustrating an LCU setting change process of the MFP according to the first embodiment of the invention.

FIG. 7 is a flowchart illustrating a new setting switch instruction process of the MFP according to the first embodiment of the invention.

FIG. 8 is a flowchart illustrating a request execution process of the LCU according to the first embodiment of the invention.

FIG. 9 is a flowchart illustrating an LCU setting change process of the MFP according to a second embodiment of the invention.

FIG. 10 is a flowchart illustrating a request execution process of the LCU according to the second embodiment of the invention.

### DETAILED DESCRIPTION

Hereinafter, exemplary embodiments according to aspects of the present invention will be described with reference to the accompany drawings.

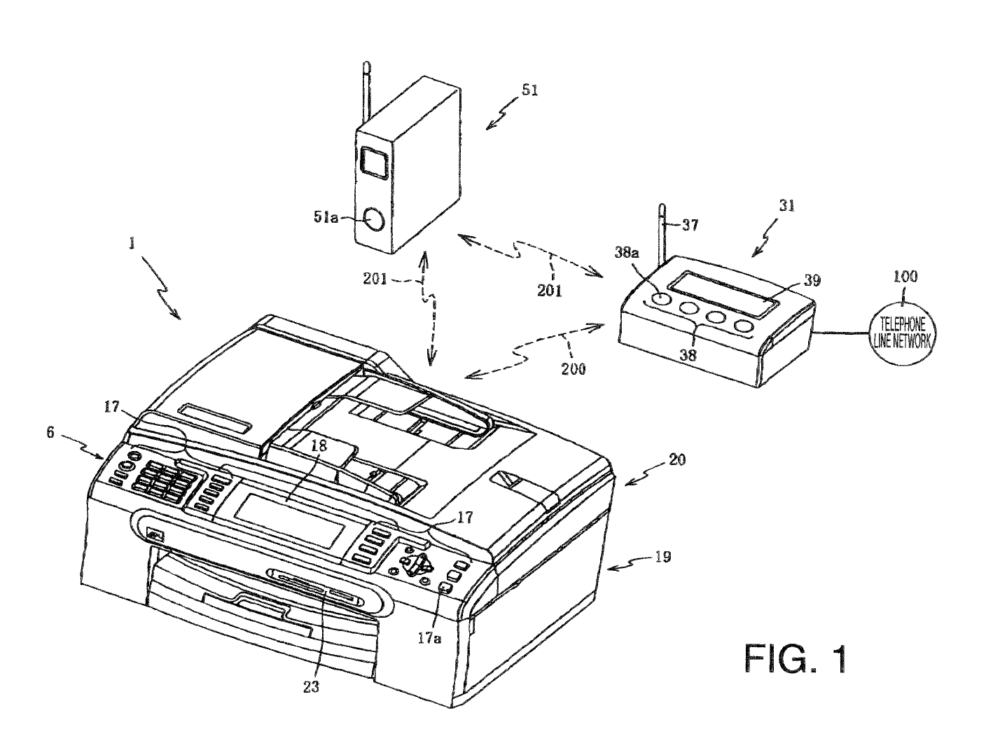

A wireless communication system includes an MFP (multi function peripheral) 1, an LCU (line control unit) 31 and an AP (access point) 51 (see FIG. 1).

The MFP 1 and the LCU 31 are wireless LAN clients capable of executing data communication by a wireless communication in accordance with a wireless LAN using an IP (Internet protocol). The AP 51 is a wireless LAN access point capable of executing data communication in accordance with the wireless LAN. Incidentally, examples of a communication method in accordance with the wireless LAN are those according to IEEE 802.11a/b/g/n standards.

It is known that, in wireless LAN communication, there are two communication modes, an ad-hoc mode (hereinafter, referred to as Ad mode) and an infrastructure mode (hereinafter, referred to as Inf mode). When the wireless communication is performed, one of the Ad mode and Inf mode is used. In the Ad mode, a direct communication is performed among wireless LAN clients. A wireless network 200 shown in FIG. 1 is an example of a network in which the Ad mode communication is performed. In the Inf mode, the wireless LAN clients communicate through the wireless LAN access point. A wireless network 201 shown in FIG. 1 is an example of a network in which the Inf mode communication is performed.

According to the embodiment, the MFP 1 and AP 51 are compliant with well-know wireless LAN systems such as AOSS™ (AirStation One-Touch Secure System), WPS™ (Wi-Fi Protected Setup). The MFP 1 and AP 51 are configured such that if the user depresses setting buttons 17a and 51a (see FIG. 1) once, the MFP 1 is set to execute a wireless communication through the AP 51.

Specifically, a first embodiment is configured such that one depression of the setting buttons 17a and 51a, the MFP 1 and the LCU 31 are set in condition where the data communication can be done therebetween via the same access point AP 51.

When the user depresses the setting buttons 17a and 51a once, then in MFP 1, new setting values are obtained, and it becomes possible to executes the wireless communication via the AP 51 in the Inf mode. Then, the MFP 1 transmits the new setting value to the LCU 31. Then, the LCU 31 can use the new setting value, and as a result, it also becomes possible that the LCU 31 executes the wireless communication in the Inf mode through the AP 51. Thus, both the MFP 1 and the LCU 31 are set in the state that a data communication can be done with each other via the same AP 51. Hereinafter, a process executed when the user depresses the setting buttons 17a and 51a once will occasionally be referred to as a system process.

The MFP 1 is configured such that an inkjet printer 19 is provided at a lower portion of a main body, a flat bed scanner 20 is provided at an upper portion of the main body, and an operation panel is provided at an upper portion of a front face of the main body. The operation panel 6 has operation keys 17 and LCD (liquid crystal display) 18. The operation keys 17 include a setting button 17a. When the user depresses the setting button 17a, a pairing process (described later) is evoked.

The LCU 31 controls a communication using a telephone line network, and is connected to the telephone line network 100. The LCU 31 is provided with operation keys 38 and an LCD 39. The operation keys 38 include a network setting reset button 38a. If the user depresses the rest button 38a, the setting values of the LCU 31 regarding the wireless LAN are reset to initial values (i.e., values when shipped from factory).

According to the embodiment, the MFP 1 and the LCU 31 are paired to correspond to each other when manufactured, and in each of the MFP 1 and the LCU 31, ID information of the MFP 1 and LCU 31 is stored so that the paired devices can be identified. Further, as an initial status, setting values regarding the wireless LAN are stored in current network setting memories 14c and 35c of the MFP 1 and LCU 31 so that the MFP 1 and the LCU 31 can perform data communication in the Ad mode. In the following description, the LCU 31 that is paired with the MFP 1 when manufactured will be referred to as a paired LCU 31.

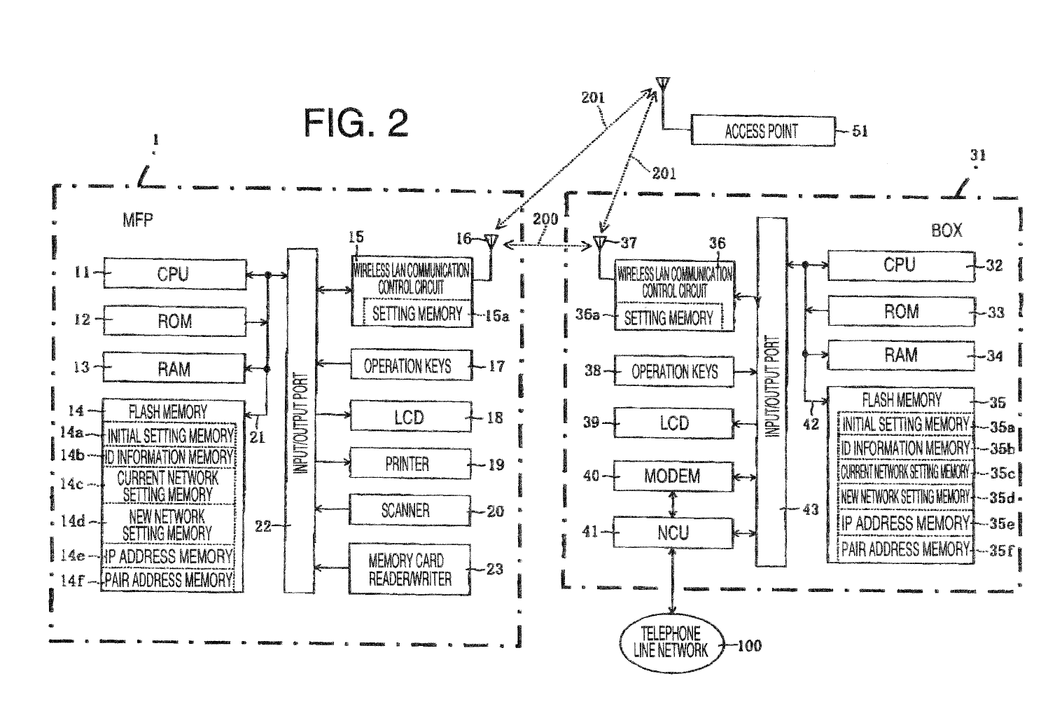

Incidentally, the setting values stored are, for example, SSID or channel number of the wireless LAN. The setting values are also stored in an initial setting memory 14a (see FIG. 2) of MFP 1 and an initial setting memory 35a of the LCU 31. The user can reset the setting values regarding the wireless LAN by operating respective devices 1 and 3. As identification information, serial IDs assigned to the MFP 1 and LCU 31 when manufactured may be used. In the ID information memory 14b of the MFP 1, the serial ID of the LCU 31 may be stored, while the ID information memory 35b of the LCU 31, the serial ID of the MFP 1 may be stored. According to the embodiment, the MFP 1 and the LCU 31 use flash memories 14 and 35, respectively. The serial ID of the MFP 1 and the serial ID of the LCU 31 are stored in ID storage areas of the flash memory 14 and 35, respectively, when manufactured.

The MFP1 includes a CPU 11, a ROM 12, a RAM 13, a flash memory 14, a wireless LAN communication control circuit 15, operation keys 17, an LCD 18, a printer 19, a scanner 20 and a memory card reader/writer 23 (see FIG. 2). The CPU 11, the ROM 12, the RAM 13 and the flash memory 14 are interconnected through a bus line 21. Further, the wireless LAN communication control circuit 15, the operation keys 17, the LCD 18, the printer 19, the scanner 20, the bus line 21 are interconnected through an I/O (input and output) port 22.

The CPU 11 controls functions of the MFP 1 and operation of each component connected through the I/O port 22 based on programs and parameters stored in the ROM 12 and/or command signals outputted/inputted through the wireless LAN communication circuit 15.

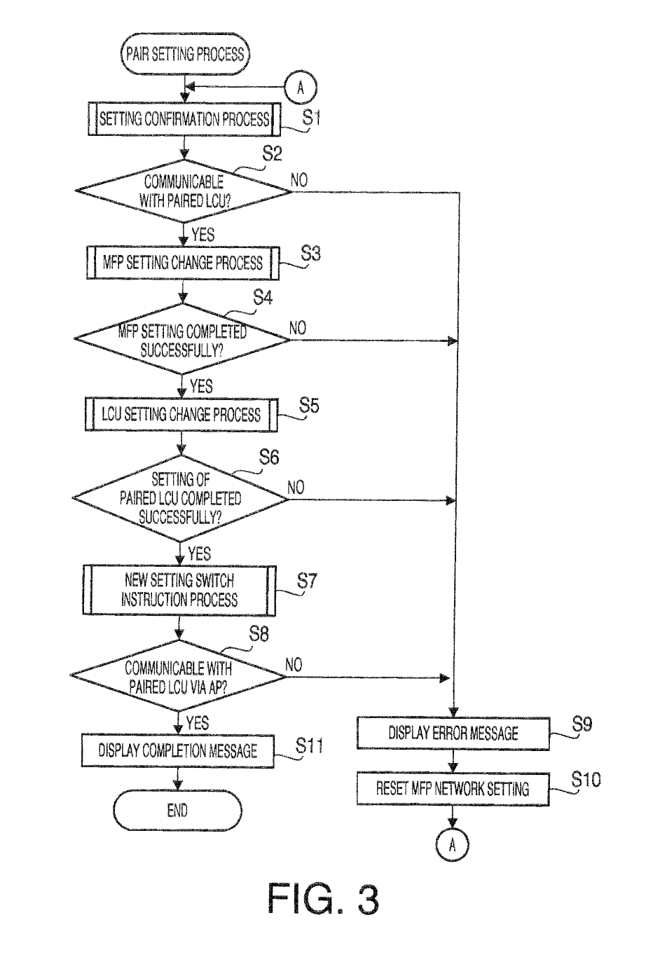

The ROM 12 is a non-volatile memory storing control programs to be executed by the MFP 1. The programs include ones that cause the MFP 1 (CPU 11) to execute processes shown in FIGS. 3-7. The RAM 13 is a rewritable volatile memory. The flash memory 14 is a rewritable non-volatile memory, and includes, in addition to the above-described initial value setting memory (area) 14a and ID information memory 14b, a current network setting memory 14c, a new network setting memory 14d, an IP address memory 14e and pair address memory 14f.

The current network setting memory 14c is a memory for storing setting values regarding the wireless LAN. When the MFP 1 is powered on, when the MFP 1 is reset, or when the setting values of the current network setting memory 14c have been changed, the CPU 11 transmits the setting values stored in the current network setting memory 14c to the wireless LAN communication control circuit 15. The CPU 11 also transmits a MAC (media access control) address stored in a not-shown area on the flash memory 14 to the wireless LAN communication control circuit 15.

The setting values for the wireless LAN include an operation mode, an authentication type, an encryption mode, an encryption key type, setting values of the encryption key and the like. The setting values are stored as the above-described process (system process) is executed.

The new network setting memory 14d is a memory configured to temporarily store new setting values when the system process is executed and setting values regarding the wireless LAN are newly obtained.

The IP address memory 14e is configured to store the IP address of the MFP 1. At a manufacturing stage, the IP address memory 14e does not store the IP address. When the MFP 1 with the shipping setting is powered ON, the CPU 11 obtains the IP address in a process according to AutoIP or DHCP (dynamic host configuration protocol), and stores the thus obtained IP address in the IP address memory 14e. Since the effective IP addresses are changed depending on the network, the CPU 11 executes a process to obtain the IP address when the setting values of the current network setting memory 14c are changed (i.e., when a connection is to be made with a new wireless network), and store the newly obtained IP address in the IP address memory 14e.

The pair address memory 14f is configured to store the IP address of the LCU 31 paired with the MFP 1. The CPU 11 obtains the IP address of the LCU 31 paired with the MFP 1 as follows. When the MFP 1 is powered on, the CPU 11 generates a packet containing the serial ID of the MFP 1, which packet is a serial ID request packet of which the request source is the MFP 1. Then, the CPU 11 transmits the serial ID request packet to the wireless LAN communication control circuit 15 by broadcasting to the wireless network (200 or 201) using SNMP (simple network management protocol).

Then, from each of the LCUs 31 (regardless whether paired or not), a reply packet containing the serial ID of the LCU 31 with a sending source being the LCU 31 and a destination being the MFP 1 is returned. The replay packet is received by the wireless LAN communication control circuit 15. Then, if there is a reply packet containing the serial ID identical to the serial ID stored in the ID information memory 14b, the CPU 11 stores the IP address of the reply packet in the pair address memory 14f.

It should be noted that a packet of which a sender is device “A” (e.g., MFP 1) contains the IP address of the device “A” as a sender information. Similarly, a packet of which recipient is the device “A” contains the IP address of the device “A” as a receiver information. Further, a packet B (e.g., a serial ID request packet) contains information indicating that the packet is the packet B.

In the following description, to transmit a packet of which a receiver is a device A will occasionally be expressed to transmit a packet to a device A. Similarly, to receive a packet of which recipient is a device A will occasionally be expressed to receive a packet from the device A.

The wireless LAN control circuit 15 is configured to control wireless data communication using the wireless LAN, and has a setting memory 15a and a wireless LAN antenna 16. The wireless LAN communication control circuit 15 is configured to exchange digital signals carrying various pieces of data with another communication device (e.g., LCU 31, AP 51 and the like). The setting memory 15a is a volatile memory storing setting values relating to the wireless LAN and MAC address, which are inputted by the CPU 11.

The LCU 31 includes a CPU 32, a ROM 33, a RAM 34, a flash memory 35, a wireless LAN communication control circuit 36, operation keys 38, an LCD 39, a MODEM 40 and an NCU 41. The CPU 32, the ROM 33, the RAM 34 and the flash memory 35 are interconnected via a bus line 42. The wireless communication control circuit 36, the operation keys 38, the LCD 39, the MODEM 40, the NCU 41 and the bus line 42 are interconnected via an I/O port 43.

The CPU 32 controls various functions and various components connected with the I/O ports 43 in accordance with various signals transmitted/received via the wireless LAN communication control circuit 36.

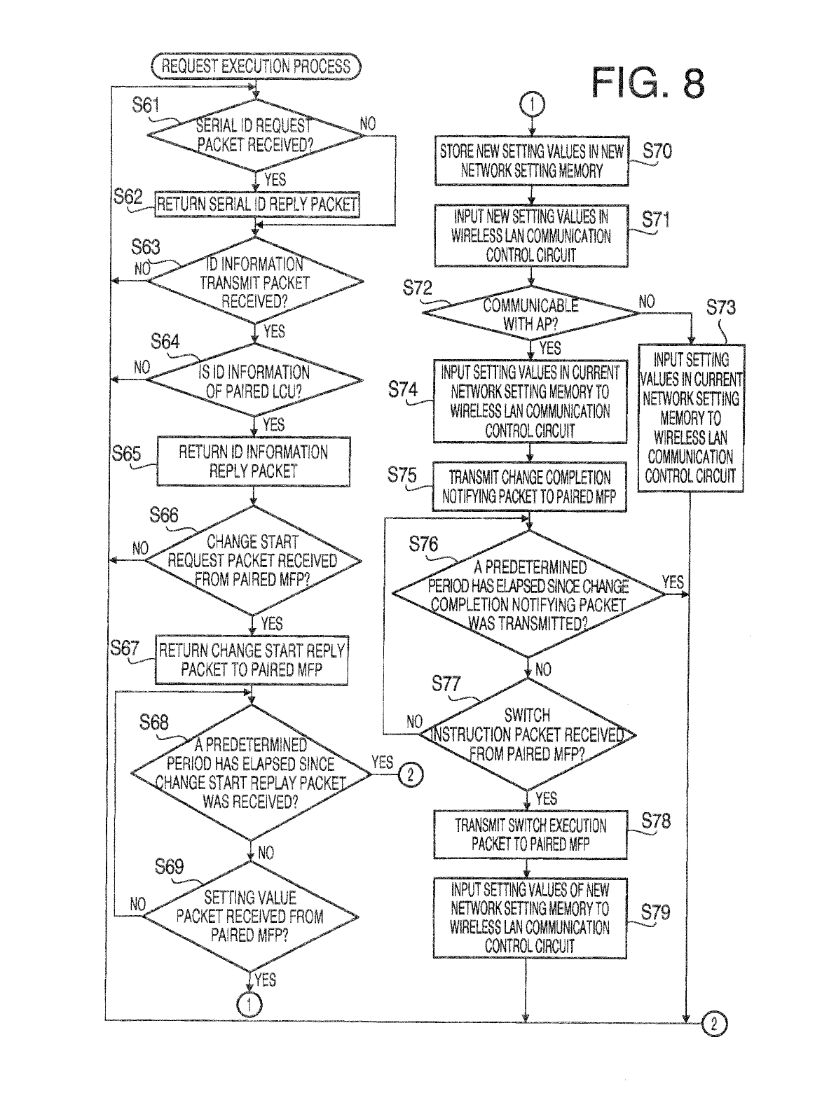

The ROM 33 is a non-rewritable memory storing control programs executed by the LCU 31. The stored programs include a program corresponding to a process shown in FIG. 8, which will be described later, and the RAM 34 is a rewritable volatile memory. The flash memory 35 is a rewritable non-volatile memory, and has an initial setting memory 35a and the ID information memory 35b described above, and further, a current network setting memory 35c, a new network setting memory 35d, an IP address memory and a pair address memory 35f.

The current network setting memory 35c is configured to store the setting values regarding the wireless LAN. When the LCU 31 is powered ON or reset, or when the setting values of the current network setting memory 35c have been changed, the CPU 32 inputs the setting values of the current network setting memory 35c into the wireless LAN communication control circuit 36. At this stage, the CPU 32 also inputs the MAC address of the LCU 31 stored in a predetermined area of the flash memory 35 to the wireless LAN communication control circuit 36.

The new network setting memory 35d is configured to temporarily store the new setting values regarding the wireless LAN if received from the MFP 1.

The IP address memory 35e is configured to store the IP address of the LCU 31.

Similar to the IP address memory 14e, the IP address memory 35e does not store the IP address when manufactured. If the LCU 31 is powered ON with the factory shipping state, the CPU 32 obtains the IP address by executing process related to the AutoIP or DHCP server, and thus obtained IP address is stored in the IP address memory 35e.

The pair address memory 35f is configured to store the IP address of the paired MFP 1. When the wireless LAN communication control circuit 36 receives the authentication information transmission packet, the CPU 32 judges whether the sender of the packet is the MFP 1 to be paired with. If the CPU 32 judges that the sender of the packet is the MFP 1 to be paired with, the CPU 32 stores the IP address, which is the sender information of the packet, to the pair address memory 35f.

The wireless LAN address control circuit 36 is configured to execute various controls of data communication in accordance with the wireless LAN, and includes a setting memory 36a and a wireless LAN antenna 37. The wireless LAN communication control circuit 36 is configured to transmit/receive digital signals constituting various types of data to/from another communication device (e.g., MFP1 or AP51). The setting memory 36a is a volatile memory configured to store setting values regarding the wireless LAN and/or MAC address inputted by the CPU 32.

The MODEM 40 is configured to modulate original document data to be transmitted by the facsimile function to a signal transmittable through the telephone line network 100 and transmits the modified signal through the NCU 41, or receive a signal from the telephone line network 100 through the NCU 41 and demodulate the received signal to the original document data.

Incidentally, the MFP 1 and the LCU 31 operate as a pair (i.e., in association with each other). For example, the MFP 1 may scan an image with the scanner 20 (alternatively, the MFP 1 may retrieve image data from a memory card with use of a card reader, or receive image data from an external device), then the MFP 1 may transmit the image data to LCU 31. When receives such image data, the LCU 31 may transmits the image data to the telephone line network 100. With above configuration, the facsimile transmission function is achieved.

For another example, the LCU 31 may receive image data from the telephone line network 100 and transmit the same to the MFP 1. Then, the MFP 1 may print out the received image data with the printer 19 (alternatively, the MFP 1 may store the image data in a memory card with a memory card writer, or may transmit the image data to an external device). With above configuration, the facsimile reception function is achieved.

When the setting button 17a of the MFP 1 is depressed, a pair setting process (see FIGS. 3-7) is evoked by the CPU 11.

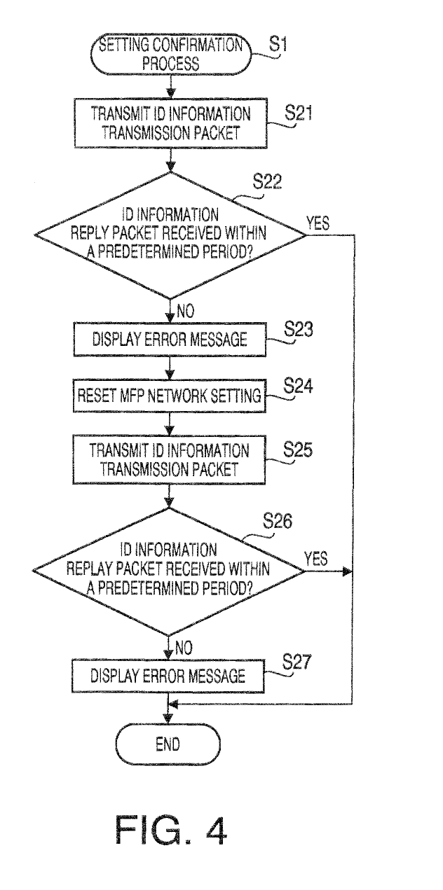

As shown in FIG. 3, when the pair setting process is started, a setting confirmation process (see FIG. 4) is executed (S1). In the setting confirmation process (FIG. 4), the MFP 1 checks whether the MFP 1 can communicate with the LCU 31 through a wireless network to which the MFP 1 is presently connected.

Specifically, the CPU 11 generates authentication information based on the serial ID of the MFP 1, which serial ID is stored in a predetermined area of the flash memory 14. Then, the CPU 11 causes the wireless LAN communication control circuit 15 (S21) to send authentication information transmission packet, which includes sender information (i.e., MFP 1), and authentication information and receiver information which is the IP address stored in the pair address memory 14f (the IP address stored in the pair address memory 14f is obtained from the LCU 31 after exchange of serial ID transmission packet and serial ID reception packet).

Then, the CPU 11 judges whether the wireless LAN communication control circuit 15 receives an authentication information reply packet which is returned by the terminal which received the authentication information transmission packet and containing the authentication information generated by the terminal device, with the receiver being set to the MFP 1, within a predetermined period after transmission of the authentication information transmission packet. Further, when the wireless LAN communication control circuit 15 receives the authentication information reply packet, the CPU 11 judges whether the authentication information contained in the authentication information reply packet is generated based on the same serial ID as the serial ID of the LCU 31 which is stored in the ID information memory 14b (S22).

If the CPU 11 judges that the authentication information reply packet cannot be received within a predetermined period after transmission of the authentication information transmission packet, or if the CPU 11 judges that the authentication information contained in the authentication information reply packet is not generated based on the serial ID same as the serial ID of the LCU 31 stored in the authentication information memory 14b (S22: NO), the CPU 11 determines that wireless communication with the LCU 31 cannot be done and display a message “Failure of Communication with LCU. Depress network setting reset button of LCU.” on the LCD 18 (S23). It should be noted that, if the user depresses the network setting reset button 38a of the LCU 31, as described above, the setting values of the LCU 31 regarding the wireless LAN are reset to values stored in the initial setting memory 35a (i.e., set to initial values).

Next, the CPU 11 changes the setting values of the MFP 1 regarding the wireless LAN to the values stored in the initial setting memory 14a (i.e., initial values) (S24). It should be noted that the setting values of the MFP 1 and the LCU 31 regarding the wireless LAN are changed to the initial values, as in the shipping condition, the MFP 1 and the LCU 31 can execute the data communication with each other in Ad mode.

After pausing for a predetermined period, in S26, the CPU 11 causes the wireless LAN communication control circuit 15 to transmit the authentication information transmission packet as in S21, and executes judgment similar to S22.

If the judgment in S26 is negative, the CPU 11 determines that the wireless communication with the LCU 31 cannot be performed and displays a message “Failure of Communication with LCU.” on the LCD 18 (S27) and terminates the current process.

If the judgment in S26 is affirmative, or the judgment in S22 is affirmative, the CPU 11 determines that the wireless communication with the LCU 31 is enabled and terminates the current process.

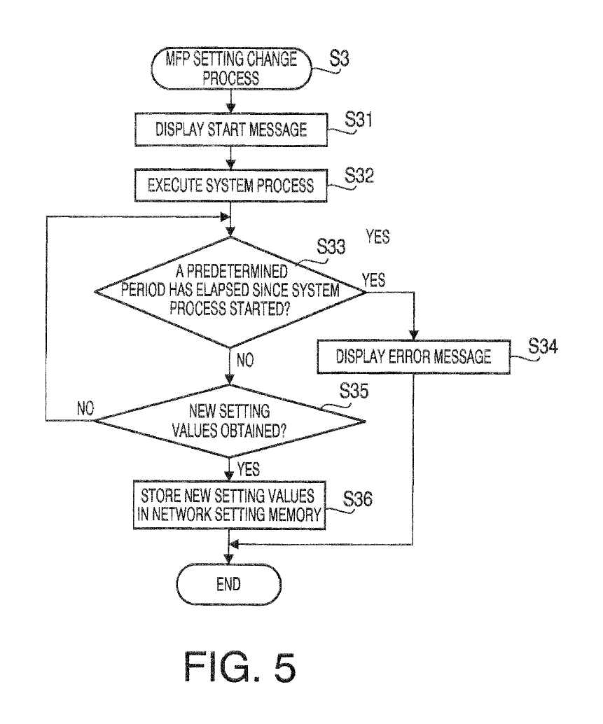

Now, FIG. 3 will be described again. When the setting confirmation process (S1) is completed, the CPU 11 judges whether the MFP 1 is capable of communicating with the paired LCU 31 (S2). If the judgment in S22 or S26 (FIG. 4) is affirmative, the judgment in S2 is affirmative, while if the judgment in S22 or S26 is negative, the judgment in S2 is negative. When the judgment in S2 is negative, the CPU 11 proceeds to S9. If the judgment in S2 is affirmative, the CPU 11 executes the MFP setting change process (S3), which will be described in detail referring to FIG. 5.

When the MFP setting change process is started, the CPU 11 firstly displays a message “Setting of MFP is started. Depress the wireless setting button of the AP (access point) and wait.” on the LCD 18 (S31).

Next, the system process described above is executed (S32). Incidentally, if wireless setting button 51a of the AP 51 is depressed, a particular data communication is executed between the MFP 1 and AP 51, and the MFP 1 obtains setting values (for wireless LAN) so that the wireless communication in Inf mode through the AP 51 is enabled.

In S33, the CPU 11 judges whether a predetermined period (i.e., a timeout period) has elapsed after the execution of the system process. If the judgment in S33 is affirmative, the CPU 11 displays a message “Wireless LAN setting function of MFP was failed.” on the LCD 18 (S34), and terminates the current process.

If the judgment in S33 is negative, the CPU 11 judges whether new setting values of the wireless LAN are obtained (S35). If the judgment in S35 is negative, the CPU 11 returns to S33. If the judgment in S35 is affirmative, the CPU 11 stores the setting values automatically obtained as the system process is executed, i.e., the newly obtained setting values regarding the wireless LAN in the new network setting memory 14d (S36), and the current process is terminated.

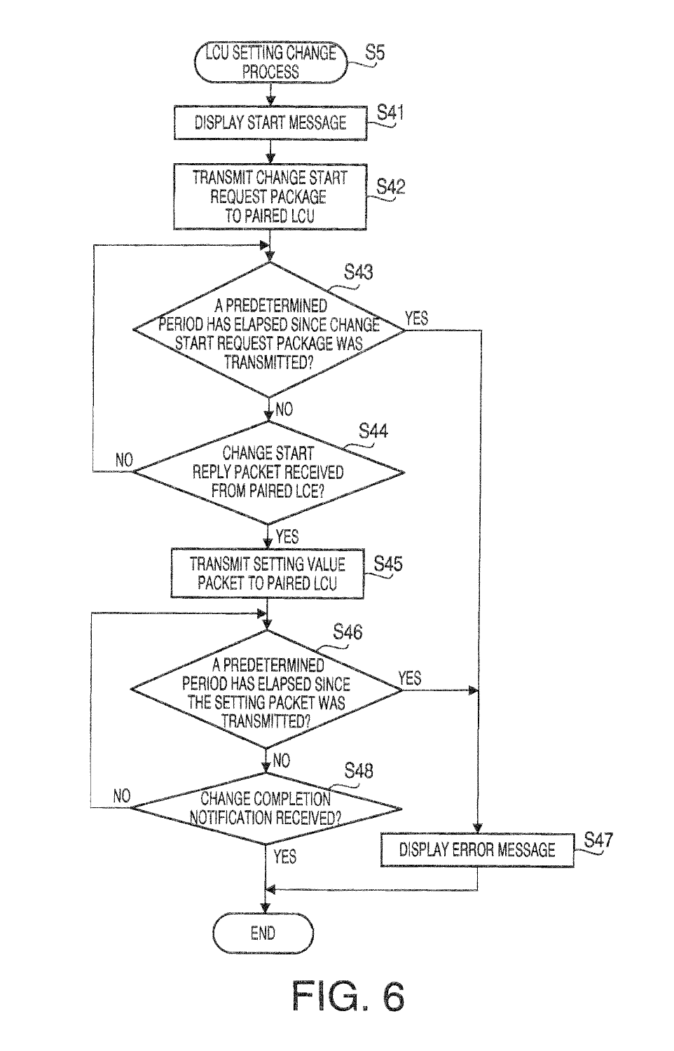

Now, description returns to FIG. 3. When the MFP setting change process is terminated, the CPU 11 judges whether the setting of the MFP 1 is completed successfully (S4). Specifically, if the judgment in S35 of FIG. 5 is YES, the judgment in S4 is affirmative, while the judgment in S33 is YES, the judgment in S4 is negative. If the judgment in S4 is negative, the CPU 11 proceeds to S9, while if the judgment in S4 is affirmative, the LCU setting change process is executed (S5), which will be described referring to FIG. 6.

In the LCU setting change process, the CPU 11 displays a message “Setting of LCU is started. Wait for a moment.” on the LCD 18 (S41). Then, the CPU 11 transmits the change start requesting packet to the paired LCU 31 (S42). Incidentally, if the paired LCU 31 receives the change start requesting packet, the CPU 11 transmits a change start reply packet, which is a reply thereto, to the paired MFP 1 (see S67 of FIG. 8).

After transmitting the change start requesting packet to the paired LCU 31, the CPU 11 judges whether the predetermined period (i.e., the timeout period) has passed (S43). If the judgment in S43 is affirmative, the CPU 11 proceeds to S47. If the judgment in S43 is negative, the CPU 11 judges whether the change start reply packet is received from the paired LCU 31 (S44). If the judgment in S44 is negative, the CPU 11 returns to S43.

If the judgment in S44 is affirmative, the CPU 11 encrypts the setting values newly stored in the new network setting memory 14d, includes the encrypted setting values in the setting value packet, and transmits the same to the paired LCU 31 (S45). It should be noted that the data may be encrypted when transmitted. Optionally, the encryption may be done in accordance with the encryption method in accordance with the wireless LAN. By transmitting the data with encryption, it becomes possible to prevent unauthorized access to the LCU 31 or AP 51, unauthorized browsing of data, or falsification of data.

After transmitting the setting value packet to the paired LCU 31, the CPU 11 judges whether the predetermined time (i.e., the timeout period) has passed (S46). After the setting packet is transmitted to the LCU 31 in S45, and when the paired LCU 31 receives the transmitted setting packet, the setting values are stored in the new network setting memory 35d (see S70 of FIG. 8). Then, when the setting values are successfully stored, the LCU 31 transmits a change completion notifying packet to the paired MFP 1 (see S75 of FIG. 8).

If the judgment in S46 is affirmative, the CPU 11 displays a message “Network setting of the LCU was failed.” on the LCD 18 (S47), and terminates the current process. If the judgment in S46 is negative, the CPU 11 judges whether the change completion notifying packet is received from the paired LCU 31 (S48). The judgment in S48 is negative, the CPU 11 returns the S46. If the judgment in S48 is affirmative, the current process is terminated.

FIG. 3 will be described again. When the LCU setting change process (S5) is finished, the CPU 11 judges whether change of setting values has been completed successfully (S6). If judgment in S48 of FIG. 6 is affirmative, judgment in S6 is affirmative. If judgment in S43 or S46 is affirmative, judgment in S6 is negative. When judgment in S6 is negative, the CPU 11 proceeds to S9. If the judgment in S6 is affirmative, the CPU 11 executes new setting switch instruction process (S7).

In the new setting switch instruction process, the CPU 11 transmits a switch instruction packet to the paired LCU 31 (S51). When the paired LCU 31 receives the switch instruction packet, the paired LCU 31 transmits a switch execution packet to the MFP 1, and subsequently inputs the setting values stored in the new network setting memory 35d to the wireless LAN communication control circuit 36 (see S78 and S79 of FIG. 8). As a result, the paired LCU 31 is capable of executing a data communication with the AP 51 in the Inf mode.

Next, the CPU 11 judges whether a predetermined period (i.e., a timeout period) has passed since the CPU 11 transmitted the switch instruction packet to the paired LCU 31. If the predetermined period has passed (S52: YES), the CPU 11 displays a message “Change of Network setting of LCU has failed.” on the LCD 18 (S53) and terminates the current process. If the predetermined period has not elapsed (S52: NO), the CPU 11 judges whether the switch execution packet has been received from the paired LCU 31 (S54). If the judgment in S54 is negative, the CPU 11 returns to S52.

If the judgment in S54 is affirmative, the CPU 11 inputs the setting values stored in the new network setting memory 13d to the wireless LAN communication control circuit 15 (S55), and terminates the current process.

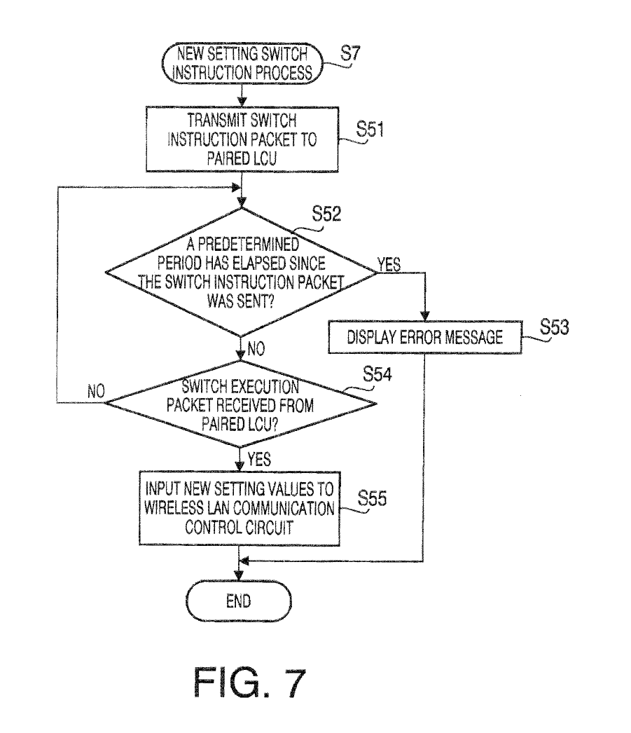

In FIG. 3, if the new setting switch instruction process (S7) is finished, the CPU 11 judges whether the MFP 1 is capable of communicating with the paired LCU 31 via the AP 51 (S8). It should be noted that if the decision in S54 (FIG. 7) is affirmative, the judgment in S8 is affirmative. If judgment in S52 is affirmative, the judgment in S8 is negative. When the judgment in S8 is negative, the CPU 11 display a message “Error has occurred during setting operation. Please depress the network setting reset button.” on the LCD 18. Thereafter, if the network setting reset button 38a of the paired LCU 31 is depressed by the user, the setting values stored in the initial setting memory 35a (i.e., the initial data) are copied as described above.

Next, the setting values stored in the initial setting memory 14a (i.e., the initial values) area copied in the current network setting memory 14c so that the setting values of the MFP 1 regarding the wireless LAN are set to the initial values (S10). Then, the process goes to 51. If, in both the MFP 1 and the LCU 31, the setting values regarding the wireless LAN, as in the case where the shipping values are set, the MFP 1 and the LCU 31 executes the data communication with each other in the Ad mode.

If the judgment in S8 is affirmative, the CPU 11 displays a message “Communication is enabled with LCU via AP. Setting of MFP and LCU was successfully completed.” in the LCD 18 (S11) and terminates the current process.

Regardless whether the judgment in S8 is affirmative, the setting values stored in the current network setting memory 14c are changed. That is, the CPU 11 executes a process of inputting the setting values stored in the current network setting memory 14c or MAC address to the wireless LAN communication control circuit 15, process of re-obtaining the IP address of the MFP 1 and storing the IP address in the IP address memory 14e, or a process of re-obtaining the IP address of the paired LCU 31 and storing the IP address in the pair address memory 14f.

With the pair setting process shown in FIG. 3, only when it is ensured that the MFP 1 and the LCU 31 can communicate with each other via the AP 51, the new setting values are stored in the current network setting memory 14c or 35c of the MFP 1 or LCU 31. Further, the user can check whether data communication can be done between the MFP 1 and the LCU 31 via the AP 51 by viewing the LCD 18.

The MFP 1 is a device having the printer 19, the scanner 20, the memory card writer 23 and the like, and the LCU 31 is a device mainly control a communication using the telephone line network 100, the MFP 1 typically has a larger housing (see FIG. 1). Thus, the MFP 1 may has the LCD having a larger display area. According to the embodiment, the user operates the LCU 31 with viewing the LCD 18 of the MFP 1. Therefore, in comparison with a case where the user views the LCD 39 of the LCU 31 and operates the same, more amount of the information can be shown. Therefore, the setting values of the LCU 31, progression of the setting value changing process can be displayed in more detailed manner, which improves the operability of the user.

Further, regardless of the communication mode, if the MFP 1 and LCU 31 cannot execute data communication with each other, or the setting values regarding the wireless LAN cannot be successfully stored in the MFP 1 or LCU 31, the MFP 1 changes the setting values regarding the wireless LAN to the initial values (factory shipping values). Further, the CPU 11 displays a message to notify the user to depress the network setting rest button 38a on the LCD 18. In this case, the CPU 11 starts the pair setting process again from the beginning.

If the network setting reset button 38a is depressed, as described above, the setting values regarding the wireless LAN of the LCU 31 are reset to the initial values (factory shipping values). As a result, the MFP 1 and the LCU 31 can execute the data communication with each other in the Ad mode.

As described above, according to the embodiment, even if an error occurs during the process of changing the setting values regarding the wireless LAN, the MFP 1 and the LCU 31 can be configured to executed the data communication with each other. Therefore, when the pair setting process is executed thereafter, in the setting confirm process (S1), the MFP 1 can communicate with the LCU 31 to be paired, and therefore, the pair setting process can be continued.

According to the embodiment, at a shipping stage, the setting values regarding the wireless LAN are set to the initial values in both the MFP 1 and the paired LCU 31. Therefore, when the user buys the MFP 1 and the LCU 31, they are already set to execute the data communication with each other in the Ad mode, and it is unnecessary for the user to execute a setting operation to make the MFP 1 and the LCU 31 be communicable with each other. Thus, for the user, it is unnecessary to execute a troublesome setting operation after buying the MFP 1 and the LCU 31. That is, by simply depressing the wireless setting buttons 17a and 51a of the MFP 1 and AP 51 only once, the communication setting of the MFP 1 and the LCU 31 can be set to a state where the MFP 1 and the LCU 31 can communicate with each other via the AP 51. When the MFP 1 and the LCU 31 are in a state where they can communicate with each other through another access point, by depressing the wireless setting buttons 17a and 51a of the MFP 1 and the AP 51 once, the communication setting of the MFP 1 and the LCU 31 can be changed to a state that they can communicate with each other through the AP 51.

Next, a request execution process executed by the CPU 32 of the LCU 31 will be described. The request execution process is executed by the CPU 32 repeatedly when the LCU 31 is powered ON.

When the request execution process is started, the CPU 32 judges whether the wireless LAN communication control circuit 36 has received the serial ID request packet which was broadcast in the network (S61). If the judgment is affirmative, the CPU 32 transmits a serial ID reply packet which contains the serial ID of the LCU 31, with the sender being the LCU 31 and the receiver being the MFP 1, to the sender of the serial ID request packet (S62). Then, the CPU 32 proceeds to S63. If the judgment in S61 is negative, the CPU 32 proceeds to S63 without executing S62.

Next, the CPU 32 judges whether the ID information transmission packet transmitted to the LCU 31 is received by the wireless LAN communication control circuit 36 (S63). If the judgment is negative, the CPU 32 returns to S61, while if the judgment is affirmative, the CPU 32 judges whether the ID information included in the ID information request packet is one generated based on the serial ID equal to the serial ID of the MFP 1 stored in the ID information memory 35b (S64). If the judgment in S64 is negative, the CPU 32 returns to S61. If the judgment in S64 is affirmative, the CPU 32 returns the ID information reply packet to the sender of the ID information request packet (S65) and proceeds to S66.

In S65, the CPU 32 generates ID information based on the serial ID of the LCU 31 stored in the predetermined area of the flash memory 35. Then, the CPU 32 generates the ID information reply packet including the LCU 31 as the sender, and including the ID information and the IP address stored in the pair address memory 35f as the receiver information, and causes wireless LAN communication control circuit 36 to transmit the ID information reply packet.

Next, the CPU 32 judges whether the change start request packet is received from the paired MFP 1 (S66). If judgment in S66 is negative, the CPU 32 returns to S61. If the judgment in S66 is affirmative, the CPU 32 transmits the change start reply packet to the paired MFP 1 (S67).

After transmitting the change start reply packet to the paired MFP 1, the CPU 32 judges whether a predetermined period (i.e., timeout period) has elapsed (S68). If the judgment in S68 is affirmative, change of the setting values are failed. In such a case, the CPU 32 returns to S61. If the judgment in S68 is negative, the CPU 32 judges whether the setting value packet which is encrypted and transmitted from the paired MFP 1 is received (S69). If the judgment in S69 is negative, the CPU 32 returns to S68.

If the judgment in S69 is affirmative, the CPU 32 decrypts the received data, and the setting values regarding the wireless LAN contained in the packet are stored in the new network setting memory 35d (S70). Then, the CPU 32 inputs the newly stored setting values to the wireless LAN communication control circuit 36 (S71). If the setting values of the wireless LAN contained in the received data are correct, the status of the LCU 31 is changed such that the LCU 31 can execute data communication with the MFP 1 via the AP 51.

Next, the CPU 32 make the wireless LAN communication control circuit 36 access the AP 51 (i.e., execute authentication request and association request) and judges whether the access succeeds (S72). If the judgment in S72 is negative, which means that the change of the setting values is failed, the CPU 32 inputs the setting values stored in the current network setting memory 35c to the wireless LAN communication control circuit 36 (S73).

If the judgment in S72 is affirmative, the CPU 32 once inputs the setting values stored in the current network setting memory 35c to the wireless LAN communication control circuit 36 (S74) in order to notify the paired MFP 1 of completion of change of setting values. Then, the LCU 31 can execute data communication directly with the MFP 1 in the Ad mode.

The CPU 32 generates the change completion notifying packet using the same encryption as the setting value packet, and transmits the change completion notifying packet to the paired MFP 1 (S75). Thereafter, the CPU 32 judges whether a predetermined period (i.e., timeout period) has elapsed (S76). If the judgment in S76 is affirmative, the setting was failed. In such a case, the CPU 32 returns to S61.

If the judgment in S76 is negative, the CPU 32 judges whether the switch instruction packet is received from the paired MFP 1 (S77). If the judgment in S77 is negative, the CPU 32 returns to S76. If the judgment in S77 is affirmative, the CPU 32 generates the switch execution packet and transmits the same to the paired MFP 1 (S78).

Then, the CPU 32 inputs the setting values stored in the new network setting memory 35d to the wireless LAN communication control circuit 36 (S79). That is, the CPU 32 makes the LCU 31 communicable with the MFP 1 via the AP 51 in the Inf mode. Specifically, in S79, the CPU 32 copies the setting values stored in the new network setting memory 35d to the current network setting memory 35c. As described above, when the setting values in the current network setting memory 35c have been changed, the CPU 32 executes a process of inputting the setting values stored in the current network setting memory 35c and MAC address to the wireless LAN communication control circuit 36 and a process of re-obtaining the IP address of the LCU 31 and storing the same in the IP address memory 36e. As a result, the setting values of the new network setting memory 35d are input to the wireless LAN communication control circuit 36. Thereafter, the process returns to S61.

By the request execution process shown in FIG. 8, when the setting value packet is received from the paired MFP 1, the LCU 31 becomes communicable with the paired MFP 1 via the AP 51 based on the received packet.

As described above, according to the first embodiment, the system process is executed only by the MFP 1, and the setting value packet containing the setting values of the wireless LAN which are obtained by the system process is transmitted from the MFP 1 to the LCU 31. In the LCU 31, based on the setting value packet, the setting values regarding the wireless LAN of the LCU 31 are changed (set). Therefore, the user can set the setting values regarding the wireless LAN of the MFP 1 and the LCU 31 only by depressing the wireless setting buttons 17a and 51a once.

Next, the second embodiment according to the present invention will be described. In the second embodiment, the user is required to depress the wireless setting buttons 17a and 51a once so that the system process is executed in both the MFP 1 and the AP 51. Then, the process waits until it becomes possible that the MFP 1 communicates via the AP 51 in the Inf mode. When the MFP 1 becomes communicable with the AP 51, the process causes the LCU 31 to execute the system process, and requests the user to depress the wireless setting button 51a of the AP 51 again. As a result, the LCU 31 becomes communicable via the AP 51 in the Inf mode. Thus, the MFP 1 and LCU 31 can execute data communication through the same AP 51.

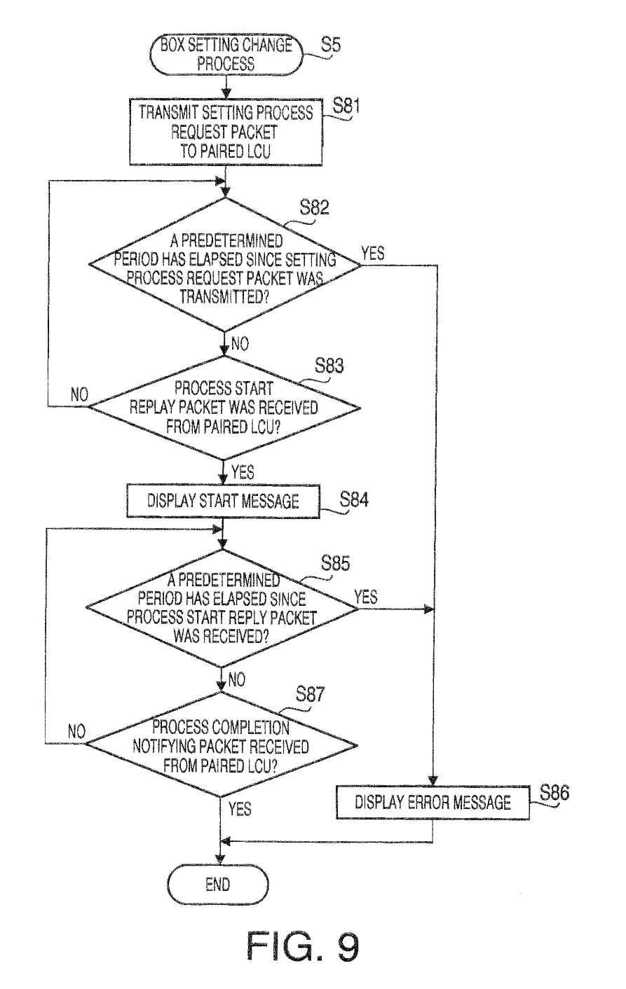

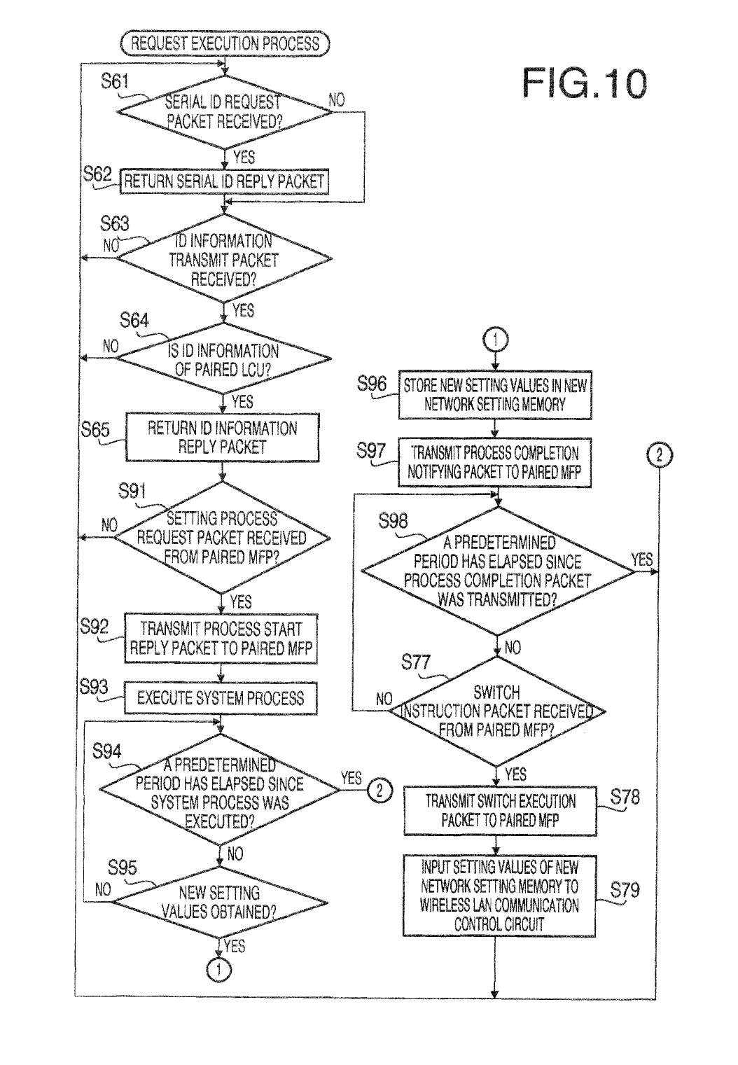

In the following description on second embodiment, only differences with respect to the first embodiment will be provided for brevity. It should be noted that, according to the second embodiment, in the ROM 12 of the MFP 1, instead of the program for the LCU setting change process shown in FIG. 6, a program for an LCU setting change process shown in FIG. 9 is stored. Further, in the ROM 33 of the LCU 31, instead of a program for the request execution process shown in FIG. 8, a program for a request execution process shown in FIG. 10 is stored.

Next, the LCU setting change process executed by the CPU 11 of the MFP 1 according to the second embodiment will be described (see FIG. 9). When the LCU setting change process is started, the CPU 11 transmits a setting process request packet to the paired LCU 31 (S81). When the paired LCU 31 receives the setting process request packet, the paired LCU 31 transmits a process start reply packet to the paired MFP 1 in response to the setting process request (S92 of FIG. 10), and executes the system process (S93 of FIG. 10).

Next, after transmitting the setting process request packet to the paired LCU 31, the CPU 11 judges whether a predetermined period (i.e., the timeout period) has elapsed (S82). If the judgment in S82 is affirmative, the CPU 11 proceeds to S86. If the judgment in S82 is negative, the CPU 11 judges whether the process start reply packet is received from the paired LCU 31 (S83). If the judgment in S83 is negative, the CPU 11 proceeds to S82.

If the judgment in S83 is affirmative, the CPU 11 displays a message “Setting of LCU is started. Depress the wireless setting button of AP and wait for a moment.” on the LCD 18 (S84).

If the wireless setting button 51a of the AP 51 is depressed, the system process is executed in the LCU 31. When the system process of the LCU 31 is executed successfully, the LCU 31 transmits the process completion notifying packet to the paired MFP 1 (S97 of FIG. 10).

Next, the CPU 11 judges whether a predetermined period (i.e., the timeout period) has elapsed since the process start reply packet is received from the paired LCU 31 (S85). If the judgment in S85 is affirmative, the CPU 11 displays a message “Wireless LAN setting function of the LCU was failed.” on the LCD 18 (S86) and terminates the current process.

If the judgment in S85 is negative, the CPU 11 judges whether the process completion notifying packet from the paired LCU 31 (S87). If the judgment in S87 is negative, the CPU 11 returns to S85. If the judgment in S87 is affirmative, the CPU 11 terminates the current process.

With the LCU setting change process shown in FIG. 9, if the wireless setting button 17a of the MFP 1 is depressed, the CPU 11 executes the system process, and thereafter, the LCU 31 also executes the system process. Therefore, it is operative since the user only operates the MFP 1 and the system processes of the MFP 1 and the LCU 31 are executed, respectively.

A request execution process according to the second embodiment executed by CPU 32 of the LCU 31 (see FIG. 10) will be described. The steps similar to those of the first embodiment will be assigned with the same reference numerals and detailed description thereof will be omitted for brevity.

As shown in FIG. 10, in the request execution process, the CPU 32 executes S61. If the judgment in S61 is affirmative, the CPU 32 executes S62 and proceeds to S63. If the judgment in S61 is negative, the CPU 32 proceeds to S63. In S63, the CPU 32 judges whether the ID information transmission packet is received. If the ID information transmission package is received (S63: YES), the CPU 32 proceeds to S64. If the judgment in S63 is negative, the CPU 32 returns to S61. In S64, the CPU 32 judges whether the received ID information is of the paired MFP 1. If the judgment in S64 is negative, the CPU 32 returns to S61, while if the judgment in S64 is affirmative, the CPU 32 proceeds to S65. When S65 is finished, the CPU 32 judges whether the setting process request packet is received from the paired MFP 1 (S91).

If the judgment in S91 is negative, the CPU 32 returns to S61. If the judgment in S91 is affirmative, the CPU 32 transmits the process start reply packet to the paired MFP 1 (S92) and executes the system process (S93).

If the wireless setting button 51a is depressed during execution of the system process, a specific data communication is executed between the LCU 31 and the AP 51. As a result, the CPU 32 obtains the setting values for the wireless LAN so that the wireless communication via the AP 51 in the Inf mode.

Next, the CPU 32 executes the system process and then judges whether a predetermined period (i.e., the timeout period) has elapsed (S94). If the judgment in S94 is affirmative, the system process was not executed normally. In such a case, the CPU 32 returns to S61.

If the judgment in S94 is negative, the CPU 32 judges whether new setting values for the wireless LAN are obtained (S95). If the judgment in S95 is negative, the CPU 32 returns to S94. If the judgment in S95 is affirmative, the CPU 32 stores the newly obtained values by executing the system process (i.e., the newly obtained values regarding the wireless LAN) in the new network setting memory 35d (S96).

Next, the CPU 32 transmits a process completion notifying packet to the paired MFP 1 (S97). After transmitting the process completion notifying packet to the paired MFP 1, the CPU 32 judges whether a predetermined period (i.e., the timeout period) has elapsed (S98). If the judgment in S98 is affirmative, which means that the process was failed, the CPU 32 returns to S61.

If the judgment in S98 is negative, the CPU 32 executes S77. If the judgment in S77 is negative, the CPU 32 returns to S98. If the judgment in S77 is affirmative, the CPU 32 executes S78 and S79 subsequently, and returns to S61.

By the request execution process shown in FIG. 10, when the setting process request packet is received from the paired MFP 1, the CPU 32 executes the system process, thereby enables the LCU 31 to execute data communication with the MFP 1 via the AP 51.

It should be noted that the above-described embodiments are exemplary ones and the invention needs not be limited to the configurations described above. Rather, various modifications can be made without departing from the scope of the invention.

For example, the setting confirmation process (FIG. 4) may be modified such that it is examined whether the setting values regarding the wireless LAN of the MFP 1 are in initial state. Alternatively, it is judged whether the communication mode of the MFP 1 is the Ad mode. In this case, the setting values regarding the wireless LAN of the LCU 31 may be regarded as those of the MFP 1, and if the judgment is affirmative, the current process is terminated, while if the judgment is negative, the CPU 32 may proceed to S23. Alternatively, if the judgment is negative, the CPU 32 may proceed to S21.

In the pair setting process (FIG. 3), the order of steps S3-S6 may be changed such that S5 and S6 may be executed first, and S3 and S4 may be executed thereafter.

In the above-described embodiments, the MFP 1 transmits ID information transmission packet (FIG. 4) in order to check whether the LCU 31 exists on the network to which the MFP 1 is connected. It may be modified such that the MFP 1 transmits other information in order to check whether the LCU 31 exits. For example, in S21 and S25, the MFP 1 may broadcast a serial ID request packet to the network, and in S22 and S26, the MFP 1 may judge whether a serial ID reply packet of which the sender is the LCU 31 to be paired is received within a predetermined period since the serial ID request packet was broadcast. In such a case, if the judgment is affirmative, the process is terminated, while if the judgment is negative, the process may proceed to next step.

In the above-described embodiments, regardless of the communication mode, if the MFP 1 and LCU 31 cannot communicate with each other or the change of the setting values regarding the wireless LAN has not been completed successfully in MFP 1 of in LCU 31, the pair setting process is re-started from the beginning. However, when the pair setting process is re-executed, the setting confirmation process (see FIG. 4) may be omitted.

Further, in the setting confirmation process (FIG. 4), if the MFP 1 confirms existence of the LCU 31, initial values (values at the time of factory shipping) may be stored in the current network setting memory 14c and 35c so that the MFP 1 and the LCU 31 can execute data communication with each other in the Ad mode, and the following steps are executed subsequently.

For example, when the MFP 1 is capable of confirming existence of the LCU 31, the MFP 1 may store the initial setting values (factory shipping values) in the current network setting memory 14c, and may display a message asking the user to depress the network setting reset button 38a on the LCD 18. If the pair setting process is executed after the MFP 1 and LCU 31 are capable of executing the data communication in the Ad mode, occurrence of the communication error can be suppressed. Accordingly, the possibility that the communication settings of both the MFP 1 and the LCU 31 to a status, where the data communication is done via the AP 51, can be raised.

In the above-described embodiments, if an error occurs during execution of changing the setting values regarding the wireless LAN, the setting operation can be done from the beginning as, in the MFP 1 and LCU 31, it is judged whether a predetermined period (i.e., the timeout period) has elapsed. However, the process may be modified such that even before elapse of the timeout period, the process is restarted if an error in changing process of the setting value regarding the wireless LAN occurs. For example, if an error occurs during execution of the setting value changing process regarding the wireless LAN in one of the MFP 1 and the LCU 31, an error notifying packet may be transmitted to the other of the MFP 1 and the LCU 31. If the other of the MFP 1 and the LCU 31 receives the error notifying packet, the setting value changing process may be executed again from the beginning without waiting for elapse of the timeout period. With such a configuration, when the setting value changing process is executed and an error occurs regarding the setting, the setting values can be re-executed and thus a waiting time before completion of the setting can be reduced.

In the new setting switch instruction process (FIG. 7) described above, only S55 may be executed and the other steps may be omitted. Further, in the request execution process (FIG. 8), steps S76-S78 may be omitted. Further, in the request execution process (FIG. 10), steps S98, S77 and S78 may be omitted. Before the new setting switch instruction process is executed, the MFP 1 and the LCU 31 must be communicable with each other. Therefore, it is very likely that when the new setting switch instruction process is executed, the MFP 1 and the LCU 31 are communicable with each other. In view of the above, in the new setting switch instruction process or request execution process, it may not be necessary to execute communication between the MFP 1 and the LCU 31 in order to check that the setting value changing process is being executed without an error. For example, in the first embodiment, S46 and S48 of the LCU setting change process may be omitted, and S51-S54 of the new setting switch instruction process may also be omitted. In association with the above omission, in the request execution process (FIG. 8), the process may be changed to return S61 after execution of S71. In the second embodiment, steps S82-S87 of the LCU setting change process (FIG. 9) may be omitted, and S51-S54 of the new setting switch instruction process may also be omitted. In association with the change, in the request execution process (FIG. 10), when the judgment in S95 is affirmative, S96 and S79 are executed, and then the process may return to S61 (i.e., S97-S78 may be omitted).

In the embodiments, as the ID information to identify the MFP 1, the MAC address of the MFP 1 is used. Further, as the ID information for identifying the LCU 31, the MAC address of the LCU 31 is used. Alternatively, manufacturing numbers intrinsic to the MFP 1 and the LCU 31 may be used as the ID information for identifying the MFP 1 and LCU 31, respectively.

In the first embodiment, the MFP 1 executes the system process, and based on the data obtained in the system process, the LCU 31 changes the setting values. Alternatively, the LCU 31 may execute the system process to obtain the setting values regarding the wireless LAN, and then the LCU 31 may transmit setting value packet M including the new setting values to the MFP 1. Then, the MFP 1 obtains the new setting values contained in the received setting value packet, and makes setting regarding the wireless LAN, so that the MFP 1 and the LCU 31 communicate with each other via the AP 51.

In the second embodiment, the MFP 1 executes the system process, and then the LCU 31 executes the system process. However, the order may be changed such that the LCU 31 executes the system process so that the LCU 31 automatically changes the setting values regarding the wireless LAN. Thereafter, the MFP 1 executes the system process so that the MFP 1 automatically sets the setting values regarding the wireless LAN.

Instead of MFP 1, a wireless setting button may be provided to the LCU 31, and the LCU 31 may be configured to executes the request execution process (FIG. 8, FIG. 10). In such a configuration, when the user operates the LCU 31 instead of the MFP 1, the setting values regarding the wireless LAN between the MFP 1 and the AP 51 may be automatically changed, respectively.

In S32 (FIG. 5) or S93 (FIG. 10), instead of the system process executed by the MFP 1 or LCU 31, the MFP 1 or LCU 31 may obtain new setting values input by the user through the operation keys 17 and 38. Alternatively, the MFP 1 may obtain the new setting values from a recording medium attached to the card reader/writer, a USB slot, or CD/DVD drive.

Optionally, the pair setting process (FIG. 3) may be executed when the CPU 11 judges that a recording medium is attached to the MFP 1. Alternatively, the pair setting process may be executed when the CPU 11 judges that new setting values are stored in the recording medium attached to the MFP 1.

The invention needs not be limited to the above-described configuration of the exemplary embodiments, but may be modified in various ways without departing from the scope of the invention. For example, the communication method needs not be limited to the wireless LAN but another communication method for the wireless communication may be employed. Examples of other communication methods may include an Infrared communication (IrDA), Blue tooth, Zig Bee, UWB, or mobile communication (the communication method of cell phone, PHS, or cordless telephone).

The LCU 31 according to the present invention is configured to execute the data communication in accordance with the wireless LAN communication method. Optionally, the MFP 1 may be provided with a function of the base phone of a cordless phone system.

In the exemplary embodiments, the MFP 1 and the LCU 31 are paired to realize the facsimile transmission function and the like. However, the invention needs not be limited to such a configuration, and any other configurations may be used if two paired devices are used. For example, the MFP 1 may be provided with a display unit capable of displaying still or animated images and speaker that outputs audio output instead of the printer 19 or scanner 20, and the LCU 31 may be configured as a network storage that stores image data and/or animated image data obtained from a recording medium, network, communication line, TV broadcast, radio broadcast. The MFP 1 may have a contents reproducing function in which the MFP 1 requests the LCU 31 for contents such as image data stored in the LCU 31, and displays the contents replied from the LCU 31 or replay (sound output) the contents transmitted from the LCU 31 as a reply. Further, the LCU 31 may be a camera that has a memory storing photograph image data and animated image data, and the MFP 1 may be configured to request the LCU 31 for contents and reproduce the contents transmitted from the LCU 31 as a reply.

The printer 19 needs not be the inkjet printer, but any other type of printers, such as a laser beam printer may be used. Further, the MFP 1 needs not be limited to the device provided with a plurality of functions, such as the functions of the printer 19 and the scanner 20. Rather, the MFP 1 may be replaced with a printer or scanner having single function.

What is claimed is:

1. A communication device, comprising:
an identification information storage configured to store identification information based on which a predetermined terminal device is identified;
an initial setting storage storing, as an initial setting, a communication setting with which a direct communication is enabled with the predetermined terminal device identified by the identification information stored in the identification information storage;
an acquiring unit configured to acquire a connection setting to connect an access point;
a transmission unit configured to transmit the connection setting acquired by the acquiring unit and an instruction to connect with the access point in accordance with the connection setting to the predetermined terminal deice in accordance with the initial setting stored in the initial setting storage; and
a setting unit configured to make the communication device connectable to the access point with the connection setting acquired by the acquiring unit after the connection setting and the instruction are transmitted by the transmission unit.

2. The communication device, according to claim 1, further comprising:
a judging unit configured to judge whether predetermined information is received from the predetermined terminal device via the access point after the setting point makes the communication device connectable to the access point;
a first initializing unit configured to make the communication device execute wireless communication with the predetermined terminal device directly if the judging unit judges that the predetermined information cannot be acquired;
a first notification unit configured to notify that the communication setting of the predetermined terminal is set to the initial setting if initialization is done by the first initialization unit; and
a re-setting unit configured to make the acquiring unit, the transmission unit, and the setting unit re-operate after notification was made using the first notification unit.

3. The communication device, according to claim 1, further comprising:
a confirming unit configured to confirm whether wireless communication with the predetermined terminal device is possible before acquiring the connection setting by the acquiring unit;
a second initializing unit configured to make the communication device execute wireless communication with the predetermined terminal device directly in accordance with the initial setting if the confirming unit judges that the wireless communication cannot be done; and
a second notifying unit configured to notify the communication setting of the predetermined terminal device if the initialization is done by the second initialization unit.

4. The communication device according to claim 1, further comprising:
a confirming unit configured to confirm whether direct wireless communication with the predetermined terminal device in accordance with the initial setting is possible before acquiring the connection setting by the acquiring unit;
a second initializing unit configured to make the communication device execute wireless communication with the predetermined terminal device directly in accordance with the initial setting if the confirming unit judges that the wireless communication cannot be done; and
a second notifying unit configured to notify the communication setting of the predetermined terminal device if the initialization is done by the second initialization unit.

5. A communication device, comprising:
an identification information storage configured to store identification information with which a predetermined terminal device can be identified;
an initial setting storage storing, as an initial setting, a communication setting with which a direct communication is enabled with the predetermined terminal device identified by the identification information stored in the identification information storage;
a receiving unit configured to receive a connection setting to connect with an access point and an instruction to connect the communication device to connect with the access point in accordance with the connection setting from the predetermined terminal device in accordance with the initial setting stored in the initial setting storage; and
a setting unit configured to set the communication device connectable to the access point in accordance with the connection setting received by the receiving unit after receiving the connection setting and the instruction with use of the receiving unit.

6. A wireless communication system, comprising:
a first communication device comprising a first identification information storage storing first identification information based on which a second communication device is identified, and a first initial setting storage storing, as initial setting, a communication setting enabling a direct wireless communication with the second communication device identified by the first identification information stored in the first identification information storage;
a second communication device comprising a second identification information storage storing second identification information based on which the first communication device is identified, and a second initial setting storage storing, as initial setting, a communication setting enabling a direct wireless communication with the first communication device identified by the second identification information stored in the second identification information storage;
wherein the first communication device further comprises:
an acquiring unit configured to acquire a connection setting to connect with an access point;
a transmission unit configured to transmit the connection setting acquired by the acquiring unit and an instruction to connect with the access point in accordance with the connection setting to the second communication device in accordance with the initial setting stored in the first initial setting storage; and
a first setting unit configured to set the first communication device connectable to the access point in accordance with the connection setting acquired by the acquiring unit after transmitting the connection setting and the instruction with the transmission unit,
wherein the second communication device comprises:
a receiving unit configured to receive, in accordance with the initial setting stored in the second initial setting storage, the connection setting and the instruction transmitted from the first communication device using the transmission unit; and
a second setting unit configured to set the second communication device connectable to the access point in accordance with the connection setting received by the receiving unit after the connection setting and the instruction are received by the receiving unit.
